(19) United States
(12) Patent Application Publication
(10) Pub. No.: US 2020/0239013 A1
(43) Pub. Date: Jul. 30, 2020

(54) DEVICE FOR CONTROLLING FUNCTIONS FOR A VEHICLE, VEHICLE SYSTEM FOR A VEHICLE, AND METHOD FOR RESETTING ELECTRICAL CIRCUITS OF A DEVICE FOR CONTROLLING FUNCTIONS FOR A VEHICLE

(71) Applicant: Robert Bosch GmbH, Stuttgart (DE)

(72) Inventors: Florian Kraemer, Pfedelbach (DE); Robert Kornhaas, Spraitbach (DE); Steffen Klinger, Backnang (DE); Ulrich Kersken, Diekholzen (DE)

(21) Appl. No.: 16/756,150

(22) PCT Filed: Nov. 8, 2018
(86) PCT No.: PCT/EP2018/080590

§ 371 Date: Apr. 15, 2020

(30) Foreign Application Priority Data
Nov. 16, 2017 (DE) 10 2017 220 481.8

(51) Int. Cl. B60W 50/04; B60W 50/023; G05B 19/042

(52) U.S. Cl. CPC B60W 50/04; G05B 19/042; B60W 50/023

(57) ABSTRACT

A device for controlling functions for a vehicle. The device includes a monolithically integrated circuit system. The circuit system includes a one-piece substrate including a first sub-section and a second sub-section, at least one first electrical circuit for safety-noncritical functions, and at least one second electrical circuit for safety-critical functions.

### FIELD

The present invention is directed to a device, to a system and to a method for controlling functions for a vehicle. The present invention also relates to a computer program.

### BACKGROUND INFORMATION

Motor vehicles may have an electrical/electronic architecture (E/E architecture) which may be divided into different domains for particular functions. During an ignition change, control units for different domains may boot and start their operating function, depending on the domain and its task, requirements with regard to an availability of the function after an ignition change may be different.

### SUMMARY

The present invention provides a device, a vehicle system, a method, and a corresponding computer program. The measures described herein allow advantageous refinements of and improvements on the device of the present invention.

According to specific embodiments of the present invention, independent or separate reset paths may be implemented for electrical circuits having different safety classifications which are situated on a monolithically integrated circuit system, in particular, for an electrical/electronic architecture of a vehicle. A separation of reset paths for parts of a monolithically integrated circuit system may thus be provided.

In this way, safety-critical electrical circuits, for example for functions related to driving safety, and safety-noncritical electrical circuits, for example for comfort functions of the vehicle, may be activatable with the aid of separate reset lines.

Advantageously, according to specific embodiments of the present invention, in this way, on the one hand, an early availability of safety-noncritical hardware parts may be achieved, and, on the other hand, an influence of safety-directed tests may be prevented. In this way, it is also possible, with respect to a change of such electrical/electronic architectures of vehicles, to prevent that safety-noncritical functions have to subordinate themselves to safety as the top priority when mixing comfort functions and safety functions on a so-called domain processor or central processor. In particular, safety shut-off paths are to be tested for correct function in safety-directed control units during every ignition change, it being possible to simulate a fault and to check whether a shut-off function for achieving a safe state functions correctly. A fault tolerance time may be run through once, and the entire reset path of a monolithically integrated circuit system, in particular of a one-chip system, of a so-called system on a chip (SoC), may be run through once. According to specific embodiments, it may be achieved that a comfort function also remains temporally unimpaired and available during such a shut-off path test. In this way, a commercial advantage may be achieved in the case of integrated central processors.

An example device for controlling functions for a vehicle is provided in accordance with an example embodiment of the present invention, the example device including the following features:

a monolithically integrated circuit system, the circuit system including a one-piece substrate including a first sub-section and a second sub-section, at least one first electrical circuit for safety-noncritical functions, and at least one second electrical circuit for safety-critical functions, the at least one first electrical circuit being situated in the first sub-section, and the at least one second electrical circuit being situated in the second sub-section;

a monitoring unit for monitoring the circuit system;

a first reset line for resetting the at least one first electrical circuit, the at least one first electrical circuit being connectable or connected to the monitoring unit in a signal transmission-capable manner with the aid of the first reset line; and

a second reset line for resetting the at least one second electrical circuit, the at least one second electrical circuit being connectable or connected to the monitoring unit in a signal transmission-capable manner with the aid of the second reset line.

The device may represent a portion of an electrical/electronic architecture of a vehicle. The vehicle may be a motor vehicle. The monolithically integrated circuit system may be implemented as a one-chip system or a so-called SoC (system on a chip). Safety-noncritical functions may be comfort functions or functions having a safety requirement level A or B according to the Automotive Safety Integrity Level (ASIL), specified by ISO 26262 for safety-relevant systems in motor vehicles. Safety-critical functions may represent safety functions or functions having a safety requirement level B or higher, i.e., B, C, or D, according to ASIL. The monitoring unit may be designed to reset the electrical circuits or to trigger or cause a reset of the electrical circuits. A reset line may be designed as a strip conductor on a circuit board, for example, on which the circuit system is situated. The circuit system may include a multitude of terminals, for example in the form of pins or soldering surfaces. The circuit system may be connected to the circuit board via the terminals. The circuit system may be connected to the first reset line via a first of the terminals, and to the second reset line via a second of the terminals.

According to one specific embodiment of the present invention, the monitoring unit may be situated enclosed in a first housing. The circuit system may be situated enclosed in a second housing. The first housing and the second housing may be situated separately and spaced apart from one another. Both housings may be situated on a circuit board, and the monitoring unit and the circuit system may be connected to one another in a signal transmission-capable manner with the aid of at least one strip conductor running across the circuit board. Such a specific embodiment offers the advantage that a flexible adaptability to an electrical/electronic architecture of a vehicle may be achieved due to a spatial separation of the monitoring unit from the circuit system.

The monitoring unit may also be situated on a further substrate. The further substrate and the substrate of the circuit system may be situated separately from one another in the process. Such a specific embodiment offers the advantage that the monitoring unit and the circuit system may be situated spatially separated from one another as needed to satisfy a particular application scenario.

Moreover, the circuit system according to the present invention may include a first supply terminal and a second supply terminal. The first supply terminal may be situated in the first sub-section. The first supply terminal may be electrically connected to the at least one first electrical circuit. The second supply terminal may be situated in the second sub-section. The second supply terminal may be electrically connected to the at least one second electrical circuit. Such a specific embodiment offers the advantage that dedicated electrical supply voltages may be applied independently of one another to the at least one first electrical circuit and to the at least one second electrical circuit. Furthermore, it may be made possible for the monitoring unit to easily and reliably carry out a reset of the electrical circuits.

In particular, the monitoring unit may be implemented as a system basis chip or as part of a system basis chip. Such a specific embodiment offers the advantage that, in addition to a monitoring function, in particular, a voltage monitoring, and a reset function, the monitoring unit is also usable as a voltage regulator, as a bus interface (for CAN bus, LIN bus etc.), as a wakeup logic, as a power driver and the like.

Furthermore, an example vehicle system for a vehicle is provided in accordance with the present invention, the example vehicle system including the following features:

a specific embodiment of the above-described device;

a first control unit for safety-noncritical functions, the first control unit being connectable or connected to the at least one first electrical circuit of the circuit system of the device in a signal transmission-capable manner; and

a second control unit for safety-critical functions, the second control unit being connectable or connected to the at least one second electrical circuit of the circuit system of the device in a signal transmission-capable manner.

In connection with the vehicle system, one specific embodiment of the above-described device is advantageously usable or utilizable for activating the control units. The vehicle system may also include at least one additional control unit for safety-critical functions and/or at least one further control unit for safety-noncritical functions. The at least one additional control unit may be connectable or connected to the at least one second electrical circuit of the circuit system of the device in a signal transmission-capable manner. The at least one further control unit may be connectable or connected to the at least one first electrical circuit of the circuit system of the device in a signal transmission-capable manner.

According to one specific embodiment of the present invention, the first control unit may be designed to activate comfort functions having a low safety objective, in particular, functions for starting the vehicle or for opening the vehicle. The second control unit may be designed to activate safety functions having a high safety objective, in particular, functions for controlling the vehicle. Such a specific embodiment offers the advantage that, after an ignition change, both comfort functions are available at an early stage, and safety functions may be reliably checked.

An example method for resetting electrical circuits of a device for controlling functions for a vehicle is provided in accordance with the present invention, the example method including the following steps:

receiving a trigger signal for resetting; and

applying a first reset signal to a first reset line for resetting at least one first electrical circuit for safety-noncritical functions and a second reset signal to a second reset line for resetting at least one second electrical circuit for safety-critical functions in response to the trigger signal,

the at least one first electrical circuit and the at least one second electrical circuit being part of a monolithically integrated circuit system, which includes a one-piece substrate including a first sub-section and a second sub-section, the at least one first electrical circuit being situated in the first sub-section, and the at least one second electrical circuit being situated in the second sub-section,

the at least one first electrical circuit being connected to a monitoring unit for monitoring the circuit system in a signal transmission-capable manner with the aid of the first reset line, the at least one second electrical circuit being connected to the monitoring unit in a signal transmission-capable manner with the aid of the second reset line.

This example method may be implemented, for example, in software or hardware or in a mixed form made up of software and hardware, for example in a device. In the step of applying, the first reset signal may be applied at a first point in time, and the second reset signal may be applied at a second point in time. The first point in time and the second point in time may be offset relative to one another.

In addition, an example computer program product or computer program is advantageous, having program code which may be stored on a machine-readable carrier or memory medium such as a semiconductor memory, a hard disk memory or an optical memory, and which is used to carry out, implement and/or activate the steps of the method according to one of the specific embodiments described above, in particular if the program product or program is executed on a computer or a device.

Exemplary embodiments of the present invention are shown in the figures and are described in greater detail below.

### BRIEF DESCRIPTION OF THE DRAWINGS

FIG. 1 shows a schematic representation of an example device.

FIG. 2 shows a schematic representation of an example device.

FIG. 3 shows a schematic representation of a device according to one exemplary embodiment of the present invention.

FIG. 4 shows a schematic representation of a vehicle including a vehicle system according to one exemplary embodiment of the present invention.

FIG. 5 shows a flow chart of a method for resetting according to one exemplary embodiment of the present invention.

### DETAILED DESCRIPTION OF EXAMPLE EMBODIMENTS

Before exemplary embodiments of the present invention are described hereafter, first background information and basics of exemplary embodiments will be briefly addressed.

An E/E architecture which is divided into different domains, for example for the drive train, driver assistance, vehicle dynamics and active safety, is frequently used in motor vehicles. In today's vehicles, for example, different control units boot during an ignition change and start their operating function. As a function of the domain and its task, in particular, requirements with regard to an availability of the function after an ignition change are different. For example, the requirements with respect to the boot time or start-up time for functions for starting the vehicle or for opening the vehicle are more progressive than safety functions which, in particular, are needed later in the driving cycle as the vehicle is moving. In addition, safety-relevant control units according to ISO 26262 may generally require a longer boot time due to necessary start-up tests.

Requirements of, for example, less than 30 ms exist with regard to the start-up time of functions from a body computer (BCM). The BCM has, in particular, moderate safety objectives at most, which makes the start-up requirements possible. In future vehicle architectures, functions are, for example, increasingly shifted in the direction of a so-called vehicle central computer or domain master computer. In a first step for combining control units and functions in a domain master computer, in particular, comfort functions having no safety objectives as well as functions, e.g., for controlling the vehicle, which have a high safety objective, are shifted onto powerful hardware. In a subsequent step, the domain master computers are consolidated, for example, and combined into even more powerful central computers.

In the following description of favorable exemplary embodiments of the present invention, identical or similar reference numerals are used for similarly acting elements shown in the different figures, and a repeated description of these elements is dispensed with.

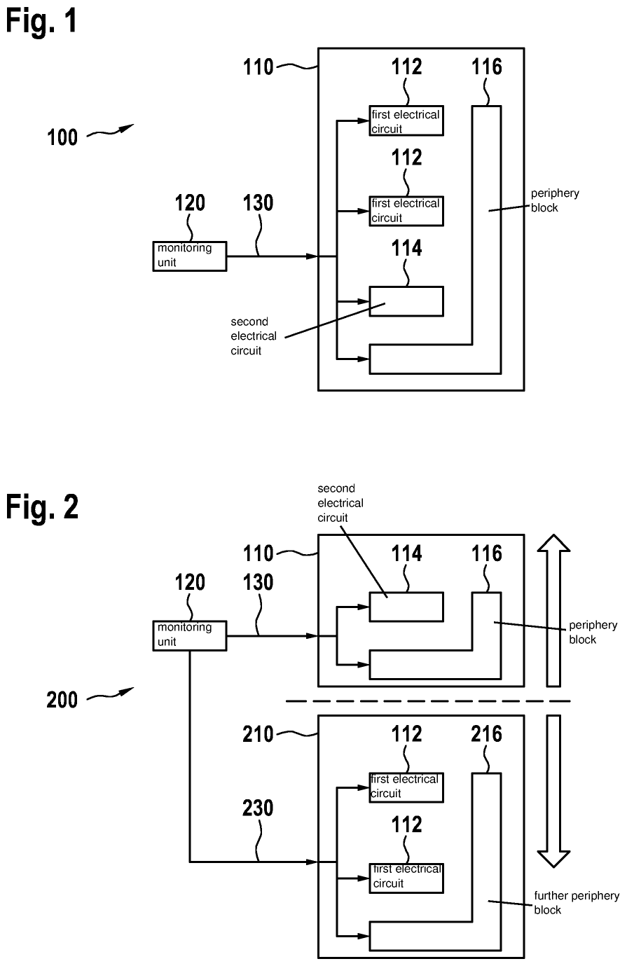

FIG. 1 shows a schematic representation of a device 100 for controlling functions for a vehicle. Device 100 includes a monolithically integrated circuit system 110, a monitoring unit 120 and a reset line 130.

By way of example, circuit system 110 only includes two first electrical circuits 112 for safety-noncritical functions, and at least one second electrical circuit 114 for safety-critical functions. Circuit system 110 furthermore includes a periphery block 116 which, for example, represents drivers for signal reception and signal output, etc. Circuit system 110 is designed as a one-chip system or SoC (system on a chip) by way of example.

Monitoring unit 120 is designed to monitor circuit system 110. Monitoring unit 120 is connected to circuit system 110 in a signal transmission-capable manner.

Reset line 130 is usable for resetting electrical circuits 112 and 114. Electrical circuits 112 and 114 and periphery block 116 are connected to monitoring unit 120 in a signal transmission-capable manner with the aid of reset line 130.

In other words, FIG. 1 shows a traditional reset connection of an SoC in a control unit or a device 100.

FIG. 2 shows a schematic representation of a device 200 for controlling functions for a vehicle. Device 200 corresponds to the device from FIG. 1, with the exception that device 200 in FIG. 2 additionally includes a further monolithically integrated circuit system 210, a further periphery block 216 and a further reset line 230.

The at least one second electrical circuit 114 and periphery block 116 are situated on circuit system 110 and connected to monitoring unit 120 in a signal transmission-capable manner with the aid of reset line 130. The, only by way of example, two first electrical circuits 112 and further periphery block 216 are situated on further circuit system 210 and connected to monitoring unit 120 in a signal transmission-capable manner with the aid of further reset line 230.

In other words, independent hardware is provided with the aid of a separate SoC on hardware in FIG. 2. This may, for example, mean cost effects and complexity effects with respect to an integration, etc.

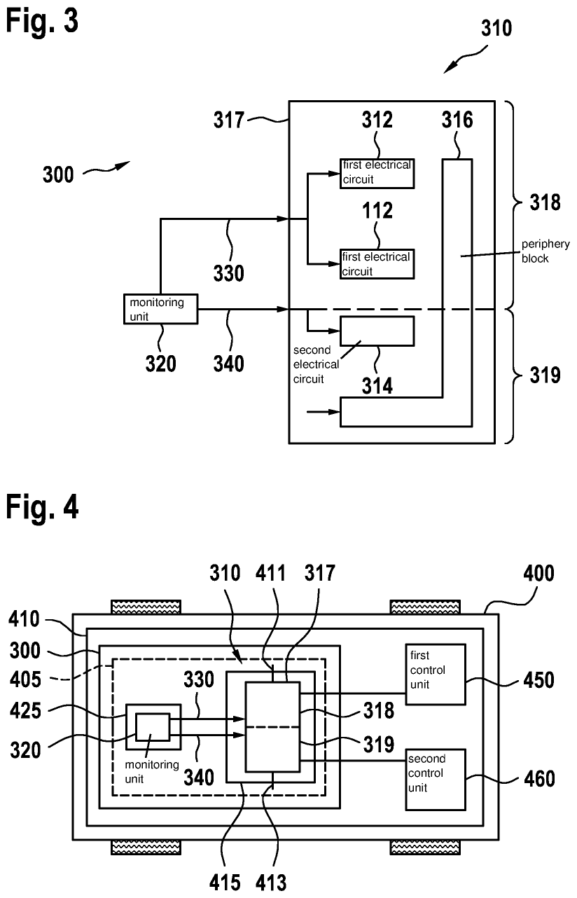

FIG. 3 shows a schematic representation of a device 300 according to one exemplary embodiment. Device 300 is a device for controlling functions for a vehicle. Device 300 is implemented as part of an electrical/electronic architecture of the vehicle. Device 300 includes a monolithically integrated circuit system 310, a monitoring unit 320, a first reset line 330 and a second reset line 340.

Monolithically integrated circuit system 310 is implemented as a one-chip system or SoC or as a processor. Only by way of example, circuit system 310 includes two first electrical circuits 312 for safety-noncritical functions, and at least one second electrical circuit 314 for safety-critical functions. Circuit system 310 furthermore includes a one-piece substrate 317 including a first sub-section 318 and a second sub-section 319. Substrate 317 is a circuit board, a conductor board or a chip. First electrical circuits 312 are situated in first sub-section 318. The at least one second electrical circuit 314 is situated in second sub-section 319.

According to the exemplary embodiment shown in FIG. 3, circuit system 310 furthermore includes a periphery block 316. Periphery block 316 includes, for example, drivers for signal reception and signal output or signal transmission. Periphery block 316 extends, in particular, across first sub-section 318 and second sub-section 319 of substrate 317 of circuit system 310.

Monitoring unit 320 is connected to circuit system 310, more precisely to electrical circuits 312 and 314, in a signal transmission-capable manner with the aid of reset lines 330 and 340. Monitoring unit 320 is designed to monitor circuit system 310. According to the exemplary embodiment shown in FIG. 3, monitoring unit 320 is implemented as a system basis chip (SBC) or as part of a system basis chip.

First reset line 330 is usable or utilizable for resetting first electrical circuits 312. Monitoring unit 320 is connected to first electrical circuits 312 in a signal transmission-capable manner with the aid of first reset line 330.

Second reset line 340 is usable or utilizable for resetting the at least one second electrical circuit 314. Monitoring unit 320 is connected to the at least one second electrical circuit 314 in a signal transmission-capable manner with the aid of second reset line 340. Second reset line 340 may also be referred to as a safety reset line 340.

FIG. 4 shows a schematic representation of a vehicle 400 including a vehicle system 410 according to one exemplary embodiment. Vehicle 100 is a motor vehicle, for example a passenger car, a truck or another commercial vehicle. Vehicle system 410 includes device 300 from FIG. 3 or a similar device.

The representation of FIG. 4 shows circuit system 310 including its substrate 317 including first sub-section 318 and second sub-section 319, monitoring unit 320, first reset line 330, second reset line 340, and additionally a circuit board 405, a first supply terminal 411, a second supply terminal 413, a second housing 415 and a first housing 425 of device 300.

According to one exemplary embodiment of the present invention, circuit board 405 may optionally be provided. Monitoring unit 320 and circuit system 310 may be situated on circuit board 405 in the process.

Circuit system 310 includes first supply terminal 411, second supply terminal 413, and second housing 415. Monitoring unit 320 includes first housing 425.

First supply terminal 411 is situated in first sub-section 318 of substrate 317 of circuit system 310. First supply terminal 411 is electrically connected to the at least one first electrical circuit. Second supply terminal 413 is situated in second sub-section 319 of substrate 317 of circuit system 310. Second supply terminal 413 is electrically connected to the at least one second electrical circuit.

Circuit system 310 is enclosed or situated in second housing 415. Monitoring unit 320 is enclosed or situated in first housing 425. First housing 425 and second housing 415 are situated physically or spatially separated from one another.

Even though this is not explicitly shown in FIG. 4, monitoring unit 320 may be situated on a further substrate, which is situated spatially or physically separated from substrate 317 of circuit system 310.

Vehicle system 410 furthermore includes a first control unit 450 for safety-noncritical functions, and a second control unit 460 for safety-critical functions. First control unit 450 is connected to circuit system 310 in a signal transmission-capable manner. First control unit 450 is connected to first sub-section 318 of substrate 317 of circuit system 310, in particular, to the at least one first electrical circuit of circuit system 310, in a signal transmission-capable manner. Second control unit 460 is connected to circuit system 310 in a signal transmission-capable manner. Second control unit 460 is connected to second sub-section 319 of substrate 317 of circuit system 310, in particular, to the at least one second electrical circuit of circuit system 310, in a signal transmission-capable manner.

In particular, first control unit 450 is designed to activate comfort functions having a low safety objective, in particular, functions for starting vehicle 400 or for opening vehicle 400. Second control unit 460 is designed to activate safety functions having a high safety objective, in particular, functions for controlling vehicle 400.

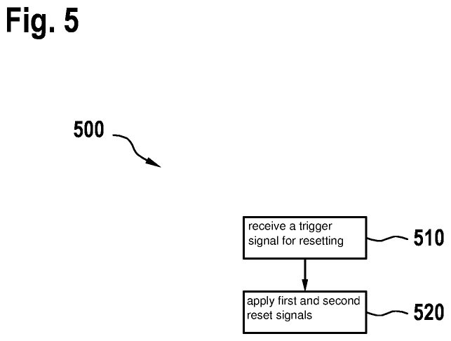

FIG. 5 shows a flow chart of a method 500 for resetting according to one exemplary embodiment of the present invention. Method 500 is executable for resetting electrical circuits of a device for controlling functions for a vehicle or for carrying out or causing a reset thereof. Method 500 for resetting is executable in connection with the device from FIG. 3 or FIG. 4 or a similar device for controlling functions for a vehicle. In particular, method 500 for resetting is executable with the aid of the monitoring unit from FIG. 3 or FIG. 4 or a similar monitoring unit.

Method 500 for resetting includes a step 510 of receiving and a step 520 of applying. In step 510 of receiving, a trigger signal for resetting is received. In step 520 of applying, in response to the trigger signal, a first reset signal is applied to the first reset line for resetting the at least one first electrical circuit for safety-noncritical functions, and a second reset signal is applied to the second reset line for resetting the at least one second electrical circuit for safety-critical functions.

If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

1-10 (canceled)

11. A device for controlling functions for a vehicle, the device comprising:
a monolithically integrated circuit system, the circuit system including a one-piece substrate including a first sub-section and a second sub-section, at least one first electrical circuit for safety-noncritical functions, and at least one second electrical circuit for safety-critical functions, the at least one first electrical circuit being situated in the first sub-section, and the at least one second electrical circuit being situated in the second sub-section;
a monitoring unit configured to monitor the circuit system;
a first reset line for resetting the at least one first electrical circuit, the at least one first electrical circuit being connected to the monitoring unit in a signal transmission-capable manner using the first reset line; and
a second reset line for resetting the at least one second electrical circuit, the at least one second electrical circuit being connected to the monitoring unit in a signal transmission-capable manner using the second reset line.

12. The device as recited in claim 11, wherein the monitoring unit is situated enclosed in a first housing, the circuit system is situated enclosed in a second housing, and the first housing and the second housing are situated separately from one another.

13. The device as recited in claim 11, wherein the monitoring unit is situated on a further substrate, the further substrate and the substrate of the circuit system are situated separately from one another.

14. The device as recited in claim 11, wherein the circuit system includes a first supply terminal and a second supply terminal, the first supply terminal being situated in the first sub-section, the first supply terminal being electrically connected to the at least one first electrical circuit, the second supply terminal being situated in the second sub-section, and the second supply terminal being electrically connected to the at least one second electrical circuit.

15. The device as recited in claim 11, wherein the monitoring unit is implemented as a system basis chip or as part of a system basis chip.

16. A vehicle system for a vehicle, the vehicle system comprising:
a device for controlling functions for the vehicle, the device including a monolithically integrated circuit system, the circuit system including a one-piece substrate including a first sub-section and a second sub-section, at least one first electrical circuit for safety-noncritical functions, and at least one second electrical circuit for safety-critical functions, the at least one first electrical circuit being situated in the first sub-section, and the at least one second electrical circuit being situated in the second sub-section, the device further including a monitoring unit configured to monitor the circuit system, a first reset line for resetting the at least one first electrical circuit, the at least one first electrical circuit being connected to the monitoring unit in a signal transmission-capable manner using the first reset line, and a second reset line for resetting the at least one second electrical circuit, the at least one second electrical circuit being connected to the monitoring unit in a signal transmission-capable manner using the second reset line;
a first control unit configured to control the safety-noncritical functions, the first control unit being connected to the at least one first electrical circuit of the circuit system of the device in a signal transmission-capable manner; and
a second control unit configured to control the safety-critical functions, the second control unit being connected to the at least one second electrical circuit of the circuit system of the device in a signal transmission-capable manner.

17. The vehicle system as recited in claim 16, wherein the first control unit is configured to activate comfort functions having a low safety objective, the comfort functions having the low safety objective including functions for starting the vehicle or for opening the vehicle, the second control unit is configured to activate safety functions having a high safety objective, the safety functions including functions for controlling the vehicle.

18. A method for resetting electrical circuits of a device for controlling functions for a vehicle, the method comprising the following steps:
receiving a trigger signal for resetting; and
applying, in response to the trigger signal, a first reset signal to a first reset line to reset at least one first electrical circuit for safety-noncritical functions and a second reset signal to a second reset line to reset at least one second electrical circuit for safety-critical functions;
wherein the at least one first electrical circuit and the at least one second electrical circuit are part of a monolithically integrated circuit system, the circuit system including a one-piece substrate including a first sub-section and a second sub-section, the at least one first electrical circuit being situated in the first sub-section, and the at least one second electrical circuit being situated in the second sub-section, the at least one first electrical circuit being connected to a monitoring unit configured to monitor the circuit system in a signal transmission-capable manner using the first reset line, and the at least one second electrical circuit being connected to the monitoring unit in a signal transmission-capable manner using the second reset line.

19. A non-transitory machine-readable storage medium on which is stored a computer program for resetting electrical circuits of a device for controlling functions for a vehicle, the computer program, when executed by a computer, causing the computer to perform the following steps:
receiving a trigger signal for resetting; and
applying, in response to the trigger signal, a first reset signal to a first reset line to reset at least one first electrical circuit for safety-noncritical functions and a second reset signal to a second reset line to reset at least one second electrical circuit for safety-critical functions;
wherein the at least one first electrical circuit and the at least one second electrical circuit are part of a monolithically integrated circuit system, the circuit system including a one-piece substrate including a first sub-section and a second sub-section, the at least one first electrical circuit being situated in the first sub-section, and the at least one second electrical circuit being situated in the second sub-section, the at least one first electrical circuit being connected to a monitoring unit configured to monitor the circuit system in a signal transmission-capable manner using the first reset line, and the at least one second electrical circuit being connected to the monitoring unit in a signal transmission-capable manner using the second reset line.
